(19) United States
(12) Patent Application Publication
(10) Pub. No.: US 2007/0244877 A1
(43) Pub. Date: Oct. 18, 2007

(54) Tracking methods for computer-readable files

(75) Inventor: Anthony A. Kempka, Backus, MN (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/403,293

(22) Filed: Apr. 12, 2006

(51) Int. Cl. G06F 17/30; G06F 7/00

(52) U.S. Cl. 707/5

(57) ABSTRACT

Apparatuses and computer-implemented methods of tracking high-risk, computer-readable files as they are accessed or created on a computing or data storage device are described according to some aspects. In one embodiment, file access events and file creation events between at least one software, middleware, or firmware application and at least one file system are monitored. When a high-risk file is created or accessed on the file systems, a unique identifier can be associated with the file and stored in a data store, which is independent of the file system. Access-event and creation-even information can then be stored to records in the data store for the high-risk files associated with unique identifiers.

### STATEMENT REGARDING FEDERALLY SPONSORED RESEARCH OR DEVELOPMENT

This invention was made with Government support under Contract DE-AC05-76RL01830 awarded by the U.S. Department of Energy. The Government has certain rights in the invention.

### BACKGROUND

With the expansion of, and increased reliance on, computing devices, computer networks, and the internet, the relative threat of malicious activity has increased. Malware can be introduced onto computer devices and/or networks from any number of sources including, but not limited to, internet web surfing, instant messaging, P2P file sharing, email attachments, and removable storage devices. Given the value of the information being stored on computing devices and traveling across computer networks, loss of data and/or operational capabilities can be very costly to owners and administrators. A great deal of effort is expended on quickly and efficiently identifying abnormal and/or malicious activities through traditional techniques such as virus signature detection and/or employment of network firewalls. However, novel (e.g., “day-zero attacks”) and/or unaddressed malware represents a chronic problem and can often escape detection and/or remediation by the traditional techniques. Therefore, a need exists for a method of alleviating threats regardless of the novelty of the malware or the source from which it is introduced.

### DESCRIPTION OF DRAWINGS

Embodiments of the invention are described below with reference to the following accompanying drawings.

FIG. 1 is a block diagram of a file tracking apparatus according to one embodiment.

FIG. 2 is a flow chart describing one embodiment of a method for tagging and tracking high-risk files.

FIG. 3 is a block diagram of an architecture for tagging and tracking high risk files according to one embodiment.

FIG. 4 is an illustrative depiction of the structure and content of information that can be stored in a record of the data store according to one embodiment.

### DETAILED DESCRIPTION

At least some aspects of the disclosure provide apparatuses and computer-implemented methods for automatically tagging and tracking high-risk files, which potentially comprise malicious code (i.e., malware), as they are created, accessed, and/or discovered on a computing or data storage device. In one embodiment, high-risk files can be associated with a unique identifier (i.e., they can be “tagged”), which is stored in a data store that is independent of the file system. Exemplary tracking can store information about access and/or creation events related to the high-risk files. For instance, file access events and file creation events between at least one software, middleware, or firmware application and at least one file system can be monitored. Information regarding access events and creation events for all tagged high-risk files can then be tracked and the information stored to records in the data store.

As used herein, the terms “file access” and “access events” can refer to activities, manipulations, and/or operations performed on, or by, the file. Examples can include, but are not limited to reading, writing, deleting, executing, launching, copying, renaming, appending, inserting, and moving. The terms “file creation” and “creation events” can refer to the specific activity and/or operation of generating a new file.

High-risk files, as used herein, can refer to files that have been designated as potentially dangerous or that pose a possible risk to system security and/or data integrity. The designation of a file as “high-risk” can be made according to risk factors associated with the file and/or the file content. Therefore, embodiments of the present invention encompass techniques that utilize one or more risk factors to identify potentially dangerous files. Examples of such techniques include, but are not limited to, rules based approaches, adaptive heuristics, and trainable pattern recognition algorithms such as artificial neural networks, support vector machines and evolutionary algorithms. Other techniques can include classification methods, for example, using risk factors in mathematical algorithms such as k-nearest neighbor, Markov chains, Bayesian classification, decision trees and multiple linear regression algorithms. In some embodiments, recognition and designation of files as high-risk is based on file content analysis such as malicious signature pattern matching and/or identification of high risk code library or API usage a file may use as well as other methods of detecting whether a file possibly harbors malicious logic.

An exemplary risk factor for recognizing high-risk files can be based on a file's ingress point. Ingress points commonly associated with a high level of risk can include, but are not limited to, potentially vulnerable software applications (e.g., web browsers, instant messaging clients, P2P file sharing software, etc.), email attachments, zip extraction, plug-and-play devices, and removable storage media such as floppy disk drives, USB thumb-drives, etc. Accordingly, in the present example, any file that enters a computer device, or is accessed, through a high-risk ingress point, would be designated as a high-risk file. Additional risk factors can be based on file name, file location, file extension, API usage, file metadata, extended data storage parameters (e.g. NTFS streams), application name, application type, storage device type, egress points, and/or combinations thereof.

In some instances, an embodiment of the present invention will be implemented (e.g., installed) onto a computing device having pre-existing files stored thereon. In such instances, the method can further comprise searching through the pre-existing files and designating appropriate files as high-risk according to the criteria, techniques, and/or processes described herein.

The unique identifier (UID), as used herein, can refer to an identifier associated with a high-risk file and is created and/or stored independently of the file's name and location. Accordingly, the UID can identify the file regardless of changes to the file's name and/or location. Examples of UIDs can include, but are not limited to, a cryptographic hash, a running sequence number, a time-stamped name, a pseudo-randomly generated number, or a combination thereof. In one embodiment, for instance, a high-risk file can be associated with a cryptographic hash, which is stored in a data store that is independent of the file system of the high-risk file. Should a property of the high-risk file change (e.g., name, location, etc.) then the association of the cryptographic hash with the file can be updated. An exemplary UID can be a 32 or 64 bit integer value.

Data store, as used herein, can refer to a persistent store of information, which information can be retrieved, modified, or created. An exemplary data store includes, but is not limited to, a database, a data table in memory, or a separate hardware device (e.g., a PCI card, USB device, etc.). Information in the data store can be organized as tracking records according to UIDs. A tracking record, as used herein, can refer to an organizational element of the data store that contains information about the tagged file. An exemplary tracking record is a database record in a database.

The file systems can be local or remote with respect to the computing device. An exemplary local file system is a direct-attach file system such as can be found on a hard disk drive, a CD-ROM drive, a USB thumb drive, etc. An exemplary remote file system is a network-based file system. Furthermore, the file system, as well as the computing device, can be distributed, clustered, or parallel. Specific instances of file systems encompassed by embodiments of the present invention include, but are not limited to, NTFS, FAT, FAT32, CDFS, CIFS, NFS, EFS, UDF, EXT, EXT2, EXT3, JFS, XFS, CXFS, GFS, PVFS, GPFS, HPFS, ZFS, DFS, XIA, MINIX, UMSDOS, VFAT, SMB, ISO9660, AFFS, UFS, and SYSV.

At least some aspects of the disclosure additionally provide apparatuses and computer-implemented methods for regulating access to tagged, high-risk files and/or monitoring to collect information (i.e., forensics). Regulation of access to such files and/or forensic information collection can include, but is not limited to, allowing, preventing and/or limiting the ability to load, read, execute, write, and/or change file attributes. Other actions can include but are not limited to, quarantining the high-risk file, subjecting the high-risk file to additional processing (e.g., spyware/adware scanning, anti-virus scanning, etc.), placing the high risk file in a virtual machine environment for additional analysis, or removing potentially dangerous components of the data file such as NTFS streams, scripts, or macro commands. In some embodiments, regulation activities are based on at least one policy. As described herein, policies can be static, dynamic, or a combination of both. In addition to regulating access, the system may also monitor and collect file access information without regulating or limiting access. This may be used for evidentiary reasons, supporting an ongoing investigation or determining the egress point of information leaving a computing infrastructure.

In some embodiments of the present invention, the computer-implemented method is executed in the kernel mode, protected mode, and/or supervisor mode of an operating system.

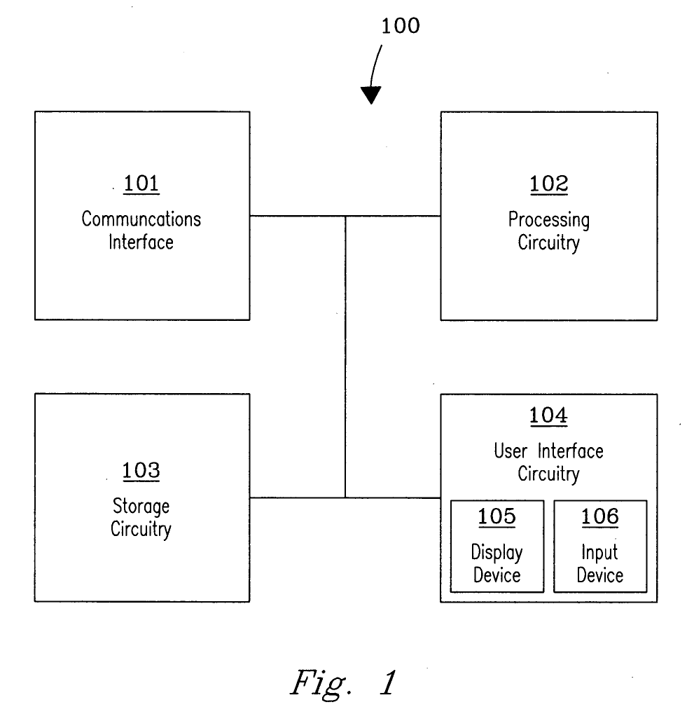

Referring to FIG. 1, an exemplary apparatus 100 is illustrated. In the depicted embodiment, the apparatus is implemented as a computing device such as a work station, server, a handheld computing device, or a personal computer, and may include a communications interface 101, processing circuitry 102, storage circuitry 103, and, optionally, a user interface 104. Other embodiments of apparatus 100 may include more, less, and/or alternative components. Furthermore, the apparatus 100 can be part of a distributed, parallel, or clustered computing system.

The communications interface 101 is arranged to implement communications of apparatus 100 with respect to a network, external device, etc. For example, communication interface 101 can be arranged to communicate information bi-directionally with respect to apparatus 100. Communications interface 100 can be implemented as a network interface card, serial connection, parallel connection, USB port, SCSI host bus adapter, Firewire interface, flash memory interface, floppy disk drive, wireless networking interface, PC card interface, PCI interface, IDE interface, SATA interface, or any other suitable arrangement for communicating with respect to apparatus 100. In an exemplary embodiment, communications interface 101 can interconnect a storage array, disk cluster, file serving device, etc. to apparatus 100 or as part of apparatus 100.

In one embodiment, communications interface 101 is configured to access files from any file systems with which apparatus 100 is interfaced, a network, the internet, and/or one or more data stores, which for example, can contain UIDs and/or tracking information for high-risk files. For example, communications interface 101 can couple apparatus 100 with an optical storage medium having CDFS and can support the accessing and/or transporting of data and/or files between apparatus 100 and the optical storage medium.

In one embodiment, processing circuitry 102 is arranged to execute computer-readable instructions, process data, control file access and storage, issue commands, and control other desired operations. Processing circuitry 102 can operate to monitor file access and creation events, associate UIDs with high-risk files, and/or control the storage of access-event information, creation-event information, and UIDs. In some embodiments, processing circuitry 102 can also operate to recognize high-risk files according to signature-based characteristics and/or at least one policy. In still other embodiments, processing circuitry 102 can operate to regulate or monitor access to files that have been recognized as high-risk. Additional details regarding associating UIDs with high-risk files and storing information about those files are described elsewhere herein according to exemplary embodiments.

Processing circuitry 102 can comprise circuitry configured to implement desired programming provided by appropriate media in at least one embodiment. For example, the processing circuitry 102 can be implemented as one or more of a processor, and/or other structure, configured to execute executable instructions including, but not limited to, software, middleware, and/or firmware instructions, and/or hardware circuitry. Exemplary embodiments of processing circuitry 102 can include hardware logic, PGA, FPGA, ASIC, state machines, and/or other structures alone or in combination with a processor. The examples of processing circuitry described herein are for illustration and other configurations are both possible and appropriate.

Storage circuitry 103 can be configured to store programming such as executable code or instructions (e.g., software, middleware, and/or firmware), electronic data (e.g., electronic files), one or more data stores, one or more file systems, and/or other digital information and can include, but is not limited to, processor-usable media. Exemplary programming can include, but is not limited to programming configured to cause apparatus 100 to monitor file access and creation events, associate UIDs with high-risk files, and/or store information regarding those high-risk files. Processor-usable media can include, but is not limited to, any computer program product or article of manufacture that can contain, store, or maintain, programming, data, data stores, file systems, and/or digital information for use by, or in connection with, an instruction execution system including the processing circuitry in the exemplary embodiments described herein. Generally, exemplary processor-usable media can refer to electronic, magnetic, optical, electromagnetic, infrared, or semiconductor media. More specifically, examples of processor-usable media can include, but are not limited to floppy diskettes, zip disks, hard drives, random access memory, read-only memory, flash memory, cache memory, compact discs, and digital versatile discs.

At least some embodiments or aspects described herein can be implemented using programming configured to control appropriate processing circuitry and stored within appropriate storage circuitry and/or communicated via a network or via other transmission media. For example, programming can be provided via appropriate media including, for example, articles of manufacture, embodied within a data signal (e.g., modulated carrier waves, data packets, digital representations, etc.) communicated via an appropriate transmission medium. Such a transmission medium can include a communication network (e.g., the internet and/or a private network), wired electrical connection, optical connection, and/or electromagnetic energy, for example, via a communications interface, or provided using other appropriate communication structures or media. Exemplary programming, including processor-usable code, can be communicated as a data signal embodied in a carrier wave, in but one example.

User interface 104 can be configured to interact with a user and/or administrator, including conveying data to the user (e.g., displaying data for observation by the user, audibly communicating data to the user, etc.) as well as to receive inputs from the user (e.g., tactile inputs, voice instructions, etc.). Accordingly, in one exemplary embodiment, the user interface 104 can include a display device 105 configured to depict visual information, and a keyboard, mouse and/or other input device 106. Examples of a display device include cathode ray tubes and LCDs.

The embodiment shown in FIG. 1 can be an integrated unit configured to associate unique identifiers with high-risk files and store information about access-events and creation-events in a data store. Other configurations are possible, wherein apparatus 100 is configured as a networked server and one or more clients are configured to access the processing circuitry and/or storage circuitry for tagging and tracking high-risk files. Alternatively, apparatus 100 can be configured as a distributed, clustered, and/or parallel computing system having a plurality of interconnected computing devices.

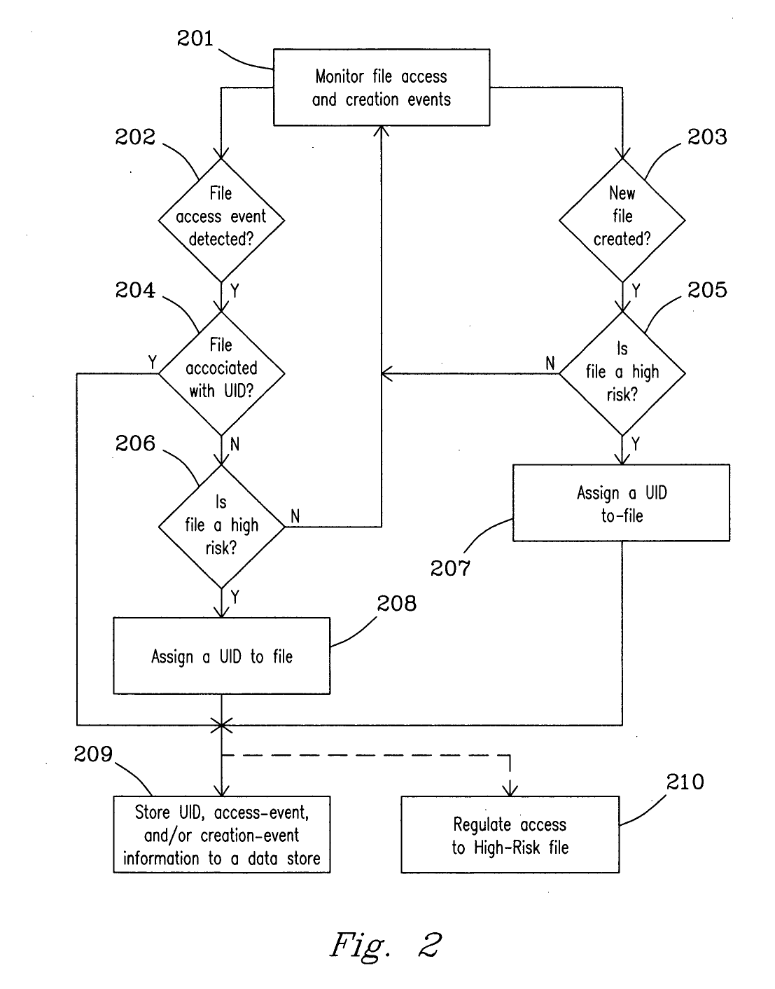

According to FIG. 2, which is a flowchart illustrating one embodiment of the methods described herein, file-access and file-creation events can be monitored 201, for example between a file system and a software, middleware, or firmware application. Examples of a software, middleware, and/or firmware applications can include, but are not limited to an operating system, software applications (e.g., word processors, internet browsers, spreadsheet programs, etc.), and system services and utilities such as storage management systems, data protection software, file transfer programs, etc. When a file-access event is detected 202 for a file already associated with a UID 204, then the access event information can be stored 209 in a data store according to the UID. If however, the file has not been tagged with a UID, a determination can be made 206 regarding the degree of risk associated with the accessed file. Such a determination can be made according to techniques and risk factors described elsewhere herein. If the file is determined to pose a high-risk, a UID is assigned 208 and the UID as well as file-access event information can then be stored 209 in the data store.

When a new file is created, a determination can be made regarding the degree of risk associated with the created file. As described herein, the determination can be based on heuristics, rule-based approaches, one or more policies and/or signature-based characteristics. If the created file is determined to pose a high-risk 205, then a UID is assigned 207 and the UID as well as file-creation event information can then be stored 209 in the data store.

In some embodiments, the optional step of regulating access 210 to high-risk files can be performed. For example, if a high-risk file is accessed, a user can be notified by a warning and/or prompted for verification to either deny or allow access to the file. Exemplary instances in which users might be prompted through a user interface, for example, include accesses such as file execute, file load, and/or any other file manipulation (e.g., renaming, copying, moving, etc.). Furthermore, the user can be given the option of assigning a default action (e.g., allow, deny, notify administrator, etc.) for all future file accesses for the specific tagged file. When implemented in a corporate enterprise environment, the access verification described herein can be performed automatically based, for example, on application of policies across the entire enterprise and/or by manual verification by the network administrator.

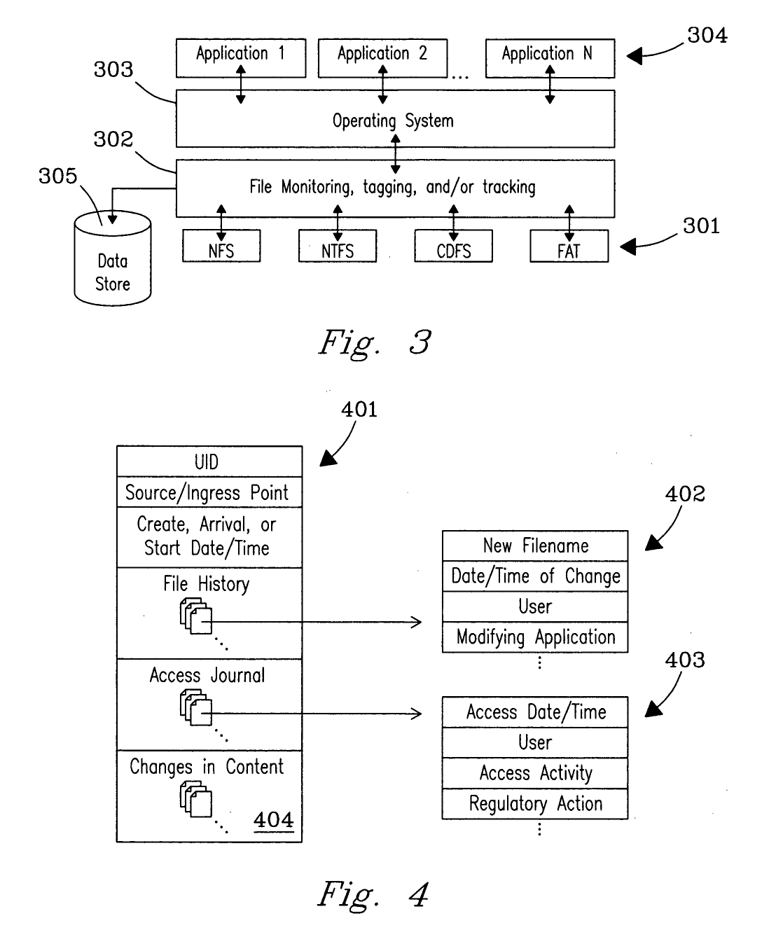

Referring to FIG. 3, an illustration shows the components of an exemplary embodiment of the present invention. According to the illustration, a computer-executable program 302 embodying the methods described herein can monitor the application 304 and the operating system 302 operations that require access to the file systems 301. While FIG. 3 depicts a distinction between applications and the operating system, the scope of the invention is not limited to such architectures and can instead include, for example, firmware, wherein the operating system and the applications can be viewed as a single monolith. Information about access-events and creation-events between applications and the file systems or the operating system and the file systems can be stored in a data store 305 that is independent of the file systems 301 being monitored. In the instant embodiment, the operating system itself can be modified to provide comprehensive and ubiquitous monitoring. For example, in some implementations, the computer-executable program 302 can operate in the kernel, the protected, and/or the supervisor mode of the operating system.

The information about access and creation events can be stored in a data store, which can comprise records for each high-risk file having a UID. Information that can be stored includes, but is not limited to, a file's UID, name, location, local date and time of creation, absolute time such as coordinated universal time (UTC), source application, current user identity, ingress point, egress point, source file system, destination file system, storage media identifier, volume name, file name hash, data content hash, and other metadata about the file, as well as the file's content. Furthermore, the stored information can comprise access activity data, which can include, but is not limited to, the access type, the access date and time, the application attempting access, the identity of the user attempting access, the location of the accessing node in networked configurations, and any regulatory action that might have been performed (e.g., allow, deny, or limit access). Further still, the stored information can comprise a list of changes that may have occurred to any of the tracked information such as the file name, location, date and time, size, as well as the file's content.

Referring to FIG. 4, one embodiment of a tracking record structure is shown illustratively. The tracking record 401 can comprise fields recording UIDs, access date and time, and source and/or ingress points. A file history field can contain subfields 402 that record data regarding each change to the file name, location, and/or other file properties. It can also record the date and time of the change, the user responsible, and the application used to modify the file. An access journal field can contain subfields 403 that record data regarding the access event itself, including, but not limited to, the access date and time, the responsible user, the access activity (e.g., read, write, load, execute, save, move, copy, delete, etc.), and any regulatory action that might have been performed (e.g., allow, deny, limit, verify, etc.). Changes in file content can be recorded in yet another field 404. Other embodiments of tracking records may include more, less, and/or alternative fields and can be structured differently.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A computer-implemented method for tracking computer-readable files as they are accessed or created on a computing or data storage device, the method comprising:
monitoring file access events and file creation events between at least one software, middleware, or firmware application and at least one file system;
associating a unique identifier with each high-risk file that is accessed or created on the file systems, wherein the unique identifiers are stored in a data store that is independent of the file systems; and
storing access-event information and creation-event information to records in the data store for the high-risk files associated with unique identifiers.

2. The method as recited in claim 1, wherein the file systems are local or remote with respect to the computing device.

3. The method as recited in claim 1, wherein the computing device, the file system, or both are distributed, clustered, parallel, or a combination thereof.

4. The method as recited in claim 1, wherein the file systems are selected from the group consisting of NTFS, FAT, FAT32, CDFS, CIFS, NFS, EFS, UFD, EXT, EXT2, EXT3, JFS, XFS, CXFS, GFS, PVFS, GPFS, HPFS, ZFS, DFS, XIA, MINIX, UMSDOS, VFAT, SMB, ISO9660, AFFS, UFS, SYSV, and combinations thereof.

5. The method as recited in claim 1, wherein the unique identifier comprises an identifier selected from the group consisting of a cryptographic hash, a running sequence number, a time-stamped name, date-stamped name, a pseudo-randomly generated number, or a combination thereof.

6. The method as recited in claim 1, wherein every file associated with a unique identifier is associated with a tracking record in the data store.

7. The method as recited in claim 1, wherein access-event information comprises access activity data.

8. The method as recited in claim 1, further comprising storing metadata about high-risk files to the appropriate record in the data store.

9. The method as recited in claim 1, further comprising storing content data about high-risk files to the appropriate record in the data store.

10. The method as recited in claim 1, further comprising recognizing high-risk files according to one or more risk factors.

11. The method as recited in claim 10, wherein risk factors are based on features associated with a file, said features selected from the group consisting of file name, file location, file extension, API usage, file metadata, extended data storage parameters (e.g. NTFS streams), application name, application type, storage device type, egress points, and combinations thereof.

12. The method as recited in claim 10, wherein said recognizing comprises implementing algorithms selected from the group consisting of adaptive heuristics, trainable pattern recognition algorithms, artificial neural networks, support vector machines, evolutionary algorithms, rules-based algorithms, classification methods using risk factors in mathematical algorithms, and combinations thereof.

13. The method as recited in claim 12, wherein said classification methods using risk factors in mathematical algorithms are selected from the group consisting of k-nearest neighbor, Markov chains, Bayesian classification, decision trees, multiple linear regression algorithms, and combinations thereof.

14. The method as recited in claim 10, wherein said risk factors are based on file content.

15. The method as recited in claim 14, wherein said recognizing utilizes file content analysis.

16. The method as recited in claim 1, further comprising regulating access to high-risk files.

17. The method as recited in claim 16, wherein said regulating is based on at least one policy.

18. The method as recited in claim 17, wherein said policies are static, dynamic, or a combination thereof.

19. The method as recited in claim 1, executed in kernel mode, protected mode, supervisor mode, or a combination thereof of an operating system.

20. The method as recited in claim 1, further comprising monitoring access events, creation events, or both for high-risk files.

21. The method as recited in claim 1, further comprising searching for pre-existing high-risk files on the file-systems.

22. A computer-readable medium having computer-executable instructions for performing the method as recited in claim 1.
